(19) United States
(12) Patent Application Publication
(10) Pub. No.: US 2025/0242363 A1
(43) Pub. Date: Jul. 31, 2025

(54) A/C Spray Nozzle Device

(71) Applicant: Dustin Thomas, Borden, IN (US)

(72) Inventor: Dustin Thomas, Borden, IN (US)

(21) Appl. No.: 18/892,621

(22) Filed: Sep. 23, 2024

Related U.S. Application Data
(60) Provisional application No. 63/626,206, filed on Jan. 29, 2024.

(51) Int. Cl. B05B 9/01; B05B 11/00

(52) U.S. Cl. CPC B05B 9/01; B05B 11/0008

(57) ABSTRACT

An A/C spray nozzle device is provided. The device is comprised of a sprayer body that receives at least one chemical-containing bag, facilitating the spraying of the chemical through the body. The body is comprised of a hose connector for fluid connection with a hose such that water can flow through the body once connected to a hose. Then, the mixture of water and chemicals can be dispensed from an adjustable tip by pressing a trigger of the device. This tip enables the user to select from various spray patterns. Additionally, the device includes a pressure-adjusting valve for water pressure control and a locking mechanism for the trigger.

### CROSS-REFERENCE TO RELATED APPLICATION

The present application claims priority to, and the benefit of, U.S. Provisional Application No. 63/626,206, which was filed on Jan. 29, 2024, and is incorporated herein by reference in its entirety.

### FIELD OF THE INVENTION

The present invention relates generally to the field of cleaning devices. More specifically, the present invention relates to an A/C spray nozzle device that provides a handheld sprayer that receives a removable bag with cleaning chemicals, wherein the device can be attached to a water source and used to spray a water and chemical fixture on an A/C unit. Accordingly, the present disclosure makes specific reference thereto. Nonetheless, it is to be appreciated that aspects of the present invention are also equally applicable to other like applications, devices, and methods of manufacture.

### BACKGROUND

Maintaining air conditioner units through regular cleaning is not only essential for optimal performance but is also crucial in averting potential breakdowns that can incur significant service or replacement costs. The process of cleaning said units often involves the use of specialized chemicals designed to remove dirt, mold, and other contaminants that can accumulate over time, impairing the air conditioner's functionality and efficiency. However, while these chemicals are effective in cleaning, they come with their own set of risks as they can pose health hazards if not used properly. Specifically, these cleaning agents can cause skin irritation or even burns if they come into direct contact with skin.

Therefore, there exists a long-felt need in the art for a device for cleaning A/C units. There also exists a long-felt need in the art for an A/C spray nozzle device. More specifically, there exists a long-felt need in the art for an A/C spray nozzle device that allows a user to spray cleaning chemicals while cleaning an A/C unit without direct exposure to said chemicals.

The subject matter disclosed and claimed herein, in one embodiment thereof, comprises an A/C spray nozzle device. The device is comprised of a sprayer body that receives at least one chemical-containing bag, facilitating the spraying of the chemical through the body. The body is comprised of a hose connector for fluid connection with a hose such that water can flow through the body once connected to a hose. Then, the mixture of water and chemicals can be dispensed from an adjustable tip by pressing a trigger of the device. This tip enables the user to select from various spray patterns. Additionally, the device includes a pressure-adjusting valve for water pressure control and a locking mechanism for the trigger.

In this manner, the A/C spray nozzle device of the present invention accomplishes all the foregoing objectives and provides a device for cleaning A/C units. More specifically, the device allows a user to spray cleaning chemicals while cleaning an A/C unit without direct exposure to said chemicals. As a result, the device prevents the possibility of skin irritation/burns.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an A/C spray nozzle device comprised of a sprayer body that receives at least one bag, wherein at least one chemical is housed within the bag and can be sprayed from the body.

The body is comprised of a handle that allows a user to grip the body. The body is also comprised of at least one hose connector that allows the body to connect to and be placed in fluid communication with a hose. The body is also comprised of a bag connection point that receives at least one fastener of an opening of a bag. The bag is preferably made from a disposable impermeable material. As a result, the bag does not allow at least one chemical stored within the bag to leak from the bag. The chemical may be any type of A/C and/or HVAC chemically used to clean air conditioning units or similar structures.

Once the bag has been secured to the connection point of the body and the body is connected to a hose via the connector, a water source can be turned on such that water flows through the body. At least one trigger can be depressed to allow a mixture of water and the chemical to be dispensed from at least one tip of the body. The tip is preferably a twisting, adjustable tip that allows a user to adjust the spray size and pattern of the water/chemical mixture.

The present invention is also comprised of a method of using the device. First, a device is provided comprised of a body comprised of at least one trigger, at least one tip, at least one hose connector, and at least one bag connection point that receives at least one bag that houses at least one chemical. Then, a bag filled with a chemical can be attached to a connection point of the body via at least one fastener of the bag. Next, the body can be secured to a hose (and water source) by attaching the hose connector to a hose. Then, the trigger can be depressed such that a water and chemical mixture is expelled from the tip and sprayed onto an A/C and/or HVAC unit to clean said unit. A user can also configure the tip to select a desired spray pattern. In addition, a user can lock the trigger in a depressed position by depressing the trigger, pressing down a locking handle, and securing the handle in a depressed position via at least one locking member.

Accordingly, the A/C spray nozzle device of the present invention is particularly advantageous as it provides a device for cleaning A/C units. More specifically, the device allows a user to spray cleaning chemicals while cleaning an A/C unit without direct exposure to said chemicals. As a result, the device prevents the possibility of skin irritation/burns. In this manner, the A/C spray nozzle device overcomes the limitations of existing methods and devices used for A/C cleaning known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of an A/C spray nozzle device of the present invention in accordance with the disclosed architecture;

FIG. 2 illustrates a perspective view of a bag of one potential embodiment of an A/C spray nozzle device of the present invention in accordance with the disclosed architecture; and

FIG. 3 illustrates a flowchart of a method of using one potential embodiment of an A/C spray nozzle device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for cleaning A/C units. There also exists a long-felt need in the art for an A/C spray nozzle device. More specifically, there exists a long-felt need in the art for an A/C spray nozzle device that allows a user to spray cleaning chemicals while cleaning an A/C unit without direct exposure to said chemicals.

The present invention, in one exemplary embodiment, is comprised of an A/C spray nozzle device. The device is comprised of a sprayer body that receives at least one bag. At least one chemical is housed within the bag and can be sprayed from the body.

The body is comprised of a handle that allows a user to grip the body and is also comprised of at least one hose connector that allows the body to connect to and be placed in fluid communication with a hose. The body is also comprised of a bag connection point that receives at least one fastener of an opening of a bag. The bag is preferably made from a disposable impermeable material. As a result, the bag does not allow at least one chemical stored within the bag to leak from the bag. The chemical may be any type of A/C and/or HVAC chemically used to clean air conditioning units or similar structures.

Once the bag has been secured to the connection point of the body and the body is connected to a hose via the connector, a water source can be turned on such that water flows through the body. At least one trigger can be depressed to allow a mixture of water and the chemical to be dispensed from at least one tip of the body. The tip is preferably a twisting, adjustable tip that allows a user to adjust the spray size and pattern of the water/chemical mixture.

The present invention is also comprised of a method of using the device. First, a device is provided comprised of a body comprised of at least one trigger, at least one tip, at least one hose connector, and at least one bag connection point that receives at least one bag that houses at least one chemical. Then, a bag filled with a chemical can be attached to a connection point of the body via at least one fastener of the bag. Next, the body can be secured to a hose (and water source) by attaching the hose connector to a hose. Then, the trigger can be depressed such that a water and chemical mixture is expelled from the tip and sprayed onto an A/C and/or HVAC unit to clean said unit. A user can also configure the tip to select a desired spray pattern. In addition, a user can lock the trigger in a depressed position by depressing the trigger, pressing down a locking handle, and securing the handle in a depressed position via at least one locking member.

Accordingly, the A/C spray nozzle device of the present invention is particularly advantageous as it provides a device for cleaning A/C units. More specifically, the device allows a user to spray cleaning chemicals while cleaning an A/C unit without direct exposure to said chemicals. As a result, the device prevents the possibility of skin irritation/burns. In this manner, the A/C spray nozzle device overcomes the limitations of existing methods and devices used for A/C cleaning known in the art.

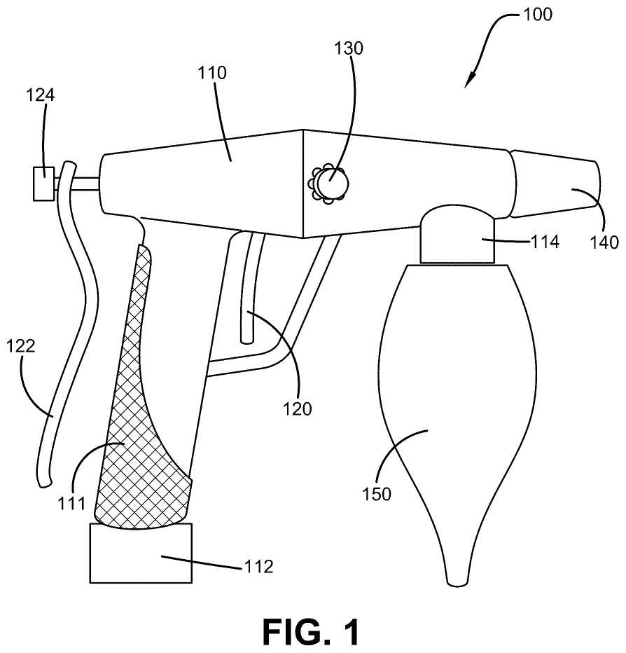

Referring initially to the drawings, FIG. 1 illustrates a side view of one potential embodiment of an A/C spray nozzle device 100 of the present invention in accordance with the disclosed architecture. The device 100 is comprised of a sprayer body 110 that receives at least one bag 150, wherein at least one chemical 156 is housed within the bag and can be sprayed from the body 110.

The body 110 may be any size, shape, and configuration of a handheld (or other) sprayer body. More specially, the body 110 is comprised of a handle 111 that allows a user to grip the body 110. The body 110 is also comprised of at least one hose connector 112. The connector 112 may be any type of connector that allows the body 110 to connect to and be placed in fluid communication with a hose. The connector 112 may include, but is not limited to, a thread, a quick connector, etc.

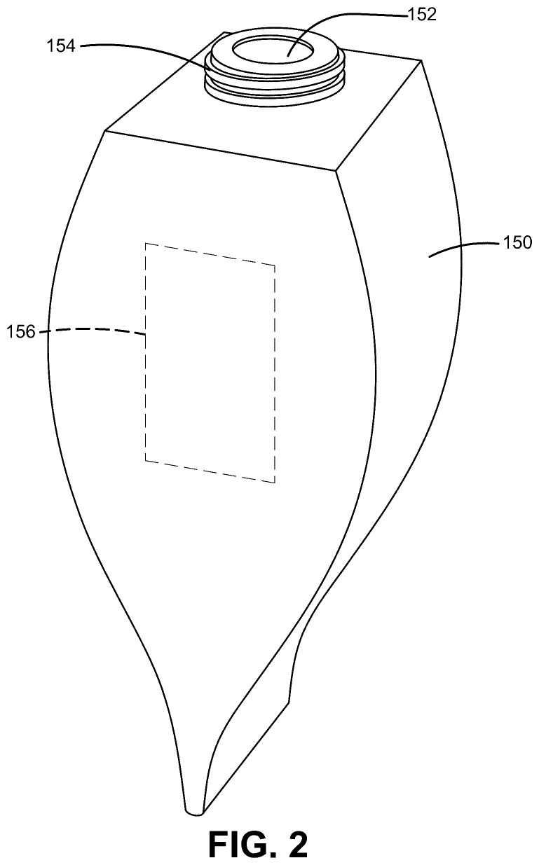

The body 110 is also comprised of a bag connection point 114. The connection point 114 receives at least one fastener 154 (as seen in FIG. 2) of an opening 152 of a bag 150. The fastener 154 and connection point 114 may be any type of reciprocating fasteners such as, but not limited to, threads. The bag 150 is preferably made from a disposable impermeable material. As a result, the bag 150 does not allow at least one chemical 156 stored within the bag 150 to leak from the bag 150. The chemical 156 may be any type of A/C and/or HVAC chemically used to clean air conditioning units or similar structures such as, but not limited to, a coil cleaning chemical, a biocide chemical, an acid chemical, an alkaline cleaner chemical, a corrosion inhibiting chemical, etc.

Once the bag 150 has been secured to the connection point 114 of the body 110 and the body 110 is connected to a hose via the connector 112, a water source can be turned on such that water flows through the body 110. At least one trigger 120 can be depressed to allow a mixture of water and the chemical 156 to be dispensed from at least one tip 140 of the body 110. The tip 140 is preferably a twisting, adjustable tip that allows a user to adjust the spray size and pattern of the water/chemical mixture. Patterns include, but are not limited to, center, full, flat, cone, angle, shower, mist, jet, rinse, etc.

Water pressure flowing through the body 110 may be adjusted via at least one pressure-adjusting valve 130. The trigger 120 can further be locked in a depressed position by pressing down at least one locking handle 122 and securing the handle 122 in said position by engaging at least one locking member 124. The locking member 124 may be any type but is preferably a twisting locking member.

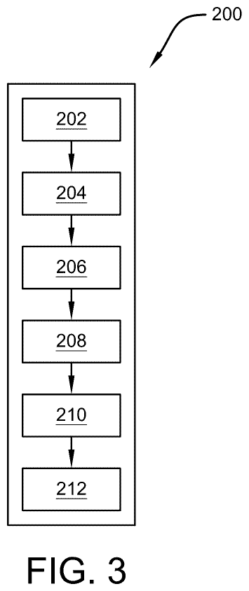

The present invention is also comprised of a method of using 200 the device 100, as seen in FIG. 3. First, a device 100 is provided comprised of a body 110 comprised of at least one trigger 120, at least one tip 140, at least one hose connector 112, and at least one bag connection point 114 that receives at least one bag 150 that houses at least one chemical 156 [Step 202]. Then, a bag 150 filled with a chemical 156 can be attached to a connection point 114 of the body 110 via at least one fastener 154 of the bag 150 [Step 204]. Next, the body 110 can be secured to a hose (and water source) by attaching the hose connector 112 to a hose [Step 206]. Then, the trigger 120 can be depressed such that a water and chemical 156 mixture is expelled from the tip 140 and sprayed onto an A/C and/or HVAC unit to clean said unit [Step 208]. A user can also configure the tip 140 to select a desired spray pattern [Step 210]. In addition, a user can lock the trigger 120 in a depressed position by depressing the trigger, pressing down a locking handle 122, and securing the handle 122 in a depressed position via at least one locking member 124 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “A/C spray nozzle device” and “device” are interchangeable and refer to the A/C spray nozzle device 100 of the present invention.

Notwithstanding the foregoing, the A/C spray nozzle device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the A/C spray nozzle device 100 as shown in the FIGS. are for illustrative purposes only, and that many other sizes and shapes of the A/C spray nozzle device 100 are well within the scope of the present disclosure. Although the dimensions of the A/C spray nozzle device 100 are important design parameters for user convenience, the A/C spray nozzle device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An A/C spray nozzle device comprising:
a body comprised of a hose connector, a bag connection point, a trigger, and a tip;
a bag comprised of an opening and a fastener; and
a chemical contained within the bag.

2. The A/C spray nozzle device of claim 1, wherein the body is comprised of a handle.

3. The A/C spray nozzle device of claim 1, wherein the hose connector is comprised of a threaded connector or a quick-connector.

4. The A/C spray nozzle device of claim 1, wherein the bag connection point receives the fastener.

5. The A/C spray nozzle device of claim 1, wherein the bag is comprised of an impermeable bag.

6. The A/C spray nozzle device of claim 1, wherein the chemical is comprised of an A/C unit cleaning chemical.

7. The A/C spray nozzle device of claim 6, wherein the chemical is comprised of a coil cleaning chemical, a biocide chemical, an acid chemical, an alkaline cleaner chemical, or a corrosion inhibiting chemical.

8. The A/C spray nozzle device of claim 1, wherein the tip produces an adjustable spray pattern.

9. An A/C spray nozzle device comprising:
a body comprised of a hose connector, a bag connection point, a trigger, a locking handle, a locking member, a pressure adjust valve, and a tip;
a bag comprised of an opening and a fastener; and
a chemical contained within the bag.

10. The A/C spray nozzle device of claim 9, wherein the body is comprised of a handle.

11. The A/C spray nozzle device of claim 9, wherein the hose connector is comprised of a threaded connector or a quick-connector.

12. The A/C spray nozzle device of claim 9, wherein the bag connection point receives the fastener.

13. The A/C spray nozzle device of claim 9, wherein the bag is comprised of an impermeable bag.

14. The A/C spray nozzle device of claim 9, wherein the chemical is comprised of an A/C unit cleaning chemical.

15. The A/C spray nozzle device of claim 14, wherein the chemical is comprised of a coil cleaning chemical, a biocide chemical, an acid chemical, an alkaline cleaner chemical, or a corrosion inhibiting chemical.

16. The A/C spray nozzle device of claim 9, wherein the tip produces an adjustable spray pattern.

17. The A/C spray nozzle device of claim 9, wherein the locking member is comprised of a twisting locking member.

18. A method of using an A/C spray nozzle device, the method comprising the following steps:
providing an A/C spray nozzle device comprised of a trigger, a tip, a hose connector, and a bag connection point that receives a bag that houses a chemical;
attaching the bag to the bag connection point;
securing the body to a hose via the hose connector;
depressing the trigger to expel a mixture of a water and the chemical from the tip and spraying the mixture onto an A/C unit.

19. The method of using an A/C spray nozzle device of claim 18, wherein the chemical is comprised of a coil cleaning chemical, a biocide chemical, an acid chemical, an alkaline cleaner chemical, or a corrosion inhibiting chemical.

20. The method of using an A/C spray nozzle device of claim 18, wherein the A/C spray nozzle device is comprised of a locking handle and a locking member.
